(19) United States
(12) Patent Application Publication
(10) Pub. No.: US 2015/0169628 A1
(43) Pub. Date: Jun. 18, 2015

(54) LOCATION DETECTION FROM QUERIES USING EVIDENCE FOR LOCATION ALTERNATIVES

(71) Applicant: Google Inc., (US)

(72) Inventor: Hartmut Maennel, Zurich (CH)

(73) Assignee: GOOGLE INC., Mountain View, CA (US)

(21) Appl. No.: 13/831,549

(22) Filed: Mar. 14, 2013

(51) Int. Cl. G06F 17/30

(52) U.S. Cl. CPC G06F 17/30241

(57) ABSTRACT

Methods, systems, and apparatus, including computer programs encoded on computer storage media, for inferring the geographical location of devices. One of the methods includes obtaining device information associated with a first device located at a respective geographical location, the device information including a plurality of events obtained from the first device, wherein least a one event of the obtained events contains ambiguous geographical location information that can be interpreted as relating to one of two or more alternative geographical locations; identifying the at least one event containing ambiguous geographical location information; and determining an estimate of the geographical location of the first device based at least in part on the device information taking into account that the at least one identified event contains ambiguous geographical location information.

### BACKGROUND

This specification relates to determining geographical locations of users and devices on a network.

Knowing the geographical location of a device coupled to a network, e.g., the Internet, can be valuable to provide new or improved services to the device or to users of the device. For instance, news, weather alerts, advertisements, and other services can be selected based on knowing where a user device is located.

### SUMMARY

This specification describes techniques for inferring the geographical location of devices based on events observed or obtained from the devices, which generally involve interactions with other network entities, including events containing ambiguous geographical location information.

In general, one innovative aspect of the subject matter described in this specification can be embodied in methods that include the actions of obtaining device information associated with a first device located at a respective geographical location, the device information including multiple events obtained from the first device, wherein least a one event of the obtained events contains ambiguous geographical location information that can be interpreted as relating to one of two or more alternative geographical locations; identifying the at least one event containing ambiguous geographical location information; and determining an estimate of the geographical location of the first device based at least in part on the device information taking into account that the at least one identified event contains ambiguous geographical location information. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The at least one event containing ambiguous geographical location information is not used to determine the estimate of geographical location of the first device. Determining an estimate of the geographical location of the first device includes: determining a first estimate of geographical location without taking the at least one event containing ambiguous geographical location information into account; resolving the ambiguity in the at least one event containing ambiguous geographical location information based on the first estimate of geographical location, wherein resolving the ambiguity includes selecting one of the two or more alternative geographical locations the event relates to; and determining a second estimate of geographical location based also on the at least one event with a resolved ambiguity. The first estimate of geographical location includes a most probable geographical location of the first device, and wherein resolving the ambiguities includes selecting a geographical location of the two or more alternative geographical locations which is closest to the most probable geographical location of the first device according to the first estimate.

Determining an estimate of the geographical location of the first device includes: determining a first estimate of geographical location without taking the at least one event containing ambiguous location information into account, wherein the first estimate of geographical location includes a most probable geographical location of the first device; generating for each of the of two or more alternative geographical locations of the at least one event containing ambiguous location information a disambiguated event not containing ambiguous location information, and determining a second estimate of geographical location taking into account the disambiguated events, wherein each of the disambiguated events is weighted according to the geographical distance of the geographical location it relates to compared to the most probable geographical location of the first device according to the first estimate of geographical location of the first device.

The method further includes: disregarding events among the disambiguated events generated from the at least one event if a geographical location the respective event relates to is farther away from the most probable geographical location of the first device according to the first estimate than a predetermined threshold. The estimate of geographical location includes a probability distribution of geographical locations which includes a probability value for each of two or more geographical locations expressing a probability that the first device is located at the respective geographical location. The first device belongs to a first group of devices, wherein the probability distribution is a probability distribution of geographical locations of the first group of devices, and wherein the determining step includes determining an estimate of the probability distribution of geographical locations of the first group of devices.

The method further includes: obtaining device information associated with a second device belonging to the first group of devices located at a respective geographical location including obtaining multiple events obtained from the second device, wherein least a one event of the events obtained from the second device contains ambiguous geographical location information that can be interpreted as relating to one of two or more alternative geographical locations; and identifying the at least one event of the events obtained from the second device containing ambiguous geographical location information; wherein determining the estimate of the probability distribution of geographical locations is based on events obtained from the first device and the second device.

The method further includes generating for each of the of two or more alternative geographical locations of the at least one event containing ambiguous location information a disambiguated event not containing ambiguous location information, and obtaining for the geographical locations of two or more geographical locations and for the disambiguated events, a probability value indicative of a probability that a respective query originated from a device located at the respective geographical location; and wherein determining the estimate of the probability distribution of geographical locations includes processing the probability values obtained. Each probability value includes a conditional probability that a respective event occurred given that the device the event originated from is located at a respective geographical location.

Determining an estimate of the geographical location of the first device includes: initializing a current probability distribution of geographical locations with an initial set of probability values; iterating, until an exit criterion is fulfilled, the actions of: computing for all events and the two or more geographical locations, a new value for conditional probabilities that a device is at a certain location given that a certain event is observed based on the current probability distribution of geographical locations and the probabilities that the certain event occurred given that a device is located at a certain geographical location; and computing a new current probability distribution of geographical locations based on the current values that a device is at a certain location given that the certain event is observed.

Particular implementations of the subject matter described in this specification can be implemented so as to realize one or more of the following advantages. The techniques described in this specification can improve the accuracy of a geographical position estimate of a device on a network, in particular, of devices on the Internet.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart of an example method to estimate a geographical location of a device.

FIG. 2 is a flowchart of a method to estimate the geographical location of a device or a group of devices based on events originating from the device or the group of devices.

FIG. 3 is a schematic drawing of an example diagram including systems in which the methods for geographical location of devices described in this specification can be carried out.

Like reference numbers and designations in the various drawings indicate like elements.

### DETAILED DESCRIPTION

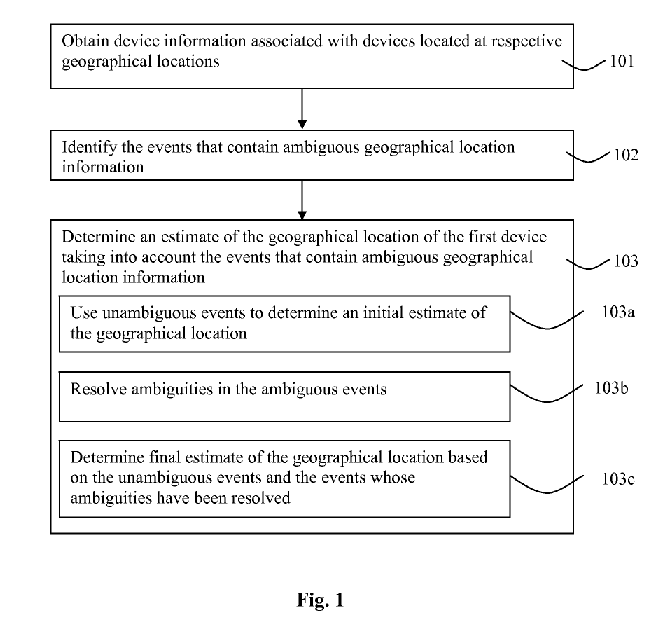

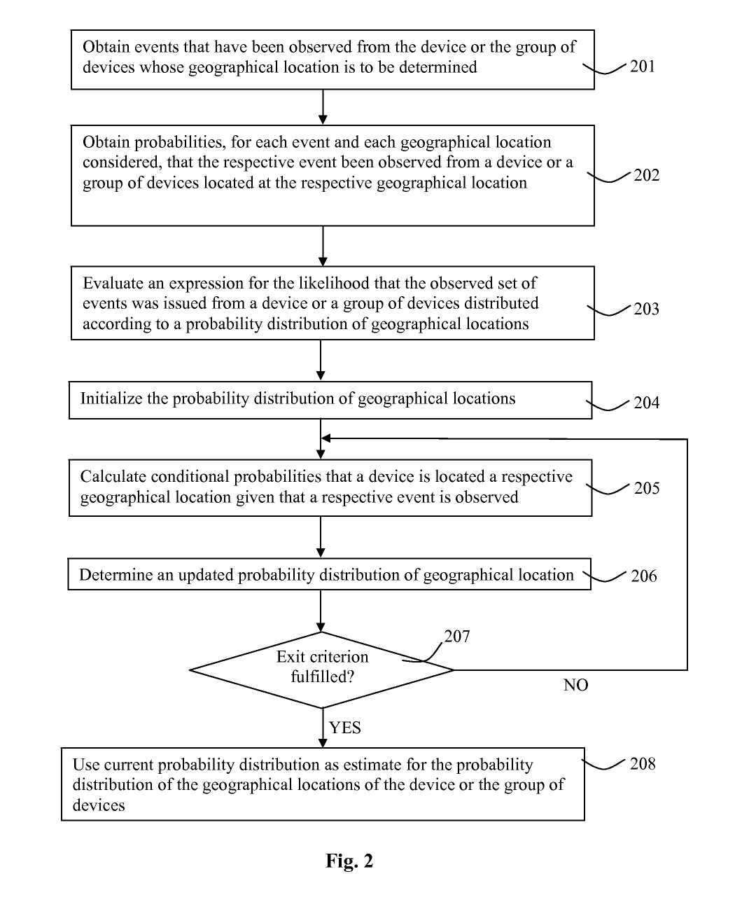

FIG. 1 is a flowchart of an example method to estimate a geographical location of a device, or a group of devices, e.g., devices associated with a particular IP block. The method will be described as being performed by a system made up of one or more computers operating in one or more locations. In particular, the method of FIG. 1 can be used on its own to estimate a geographical location or as part of another method that gives a “location distribution” for an IP block, which will be described in FIG. 2 below.

The system obtains (101) device information associated with devices located at respective geographical locations. The device information is included in events obtained from the devices.

Events are generally generated by a user device in response to a user action on the device; however, events may also be generated by the device itself. Events can be interactions of the user or the device with other devices or with resources or services on the network. Events can also be states or changes of state of the device itself that are transmitted to other devices on the network. Thus, an event can be, for example, a query received from a user device, including a search query, a map query, or a route query; a setting in a network application, e.g., a language setting, time zone or region setting, or a preference setting in a social network; a visit to one or more web pages by the user; one or several cookies stored on the device or transmitted by the device; or a posting in a social network.

Events are described in this specification as being observed, collected, received, or obtained by the system, by which is meant that data representing each of the events is observed, collected, received, or obtained by the system, and that the data includes content of the event. Of particular interest are events that include implicit or explicit information related to the geographical location of the device from which the events originated.

Example systems and methods to obtain and store events from user devices are described in U.S. patent application Ser. No. 13/458,895, the contents of which are hereby incorporated by reference in their entirety.

Thus, for example, an event can be or include a textual search query, a dictionary query, a map query, an image query, an audio query or a video query. An event can include viewport data, map coordinates, route information or any user selection of items shown on maps. An event can also include information derived from a user's selection from among search results received in response to a search query. An event can also include a URL or a sequence of URLs visited by a device. Moreover, an event can include web browser cookies or data received from a device, e.g., language settings, time zone settings or region settings. In addition, an event can include postings in a social network or a change of settings in a social network.

For situations in which the systems obtains personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographical location may be generalized where location information is obtained, such as to a city, ZIP code, or state level, so that a particular location of a user cannot be determined. Thus, the user may have control over how information is collected about him or her and used by the system. In some implementations, the systems obtain summaries of events from a group of devices, e.g., at least 50 devices in an IP block and over a longer period of time to restrict information about individual usurers.

Events may contain ambiguous geographical location information, i.e., information that can be interpreted as relating to one of two or more alternative geographical locations. An event containing ambiguous geographical location information may be referred to as an “ambiguous event”. Accordingly, an event not containing ambiguous geographical location information may be referred to as an “unambiguous event”. For example, an ambiguous event may include a reference to a location by a name that can refer to multiple different locations. Or, an ambiguous event may include two references to locations, either one of which may be interpreted as indicating a location of a device. Or, an ambiguous event may include a reference to a single location that can be interpreted in different ways for estimating the geographical location of a device.

For example, a route query event can include a start geographical location and a destination geographical location. However, it can be unknown which is closer to a current geographical location of the querying device, making the event ambiguous. Thus, the ambiguity of a route query can consist in the uncertainty about which of two geographical locations occurring in the query is closer to the querying device. A route query can also be ambiguous when it is unclear which of two geographical locations is the start point of the route query and which is the destination point.

As another example, an ambiguous event can be an event including geographical location information which relates to a name of a geographical location which exists multiple times in a geographical area of interest.

The system subsequently identifies (102) the events that contain ambiguous geographical location information. This can include identifying events that are of a type which has been determined to be ambiguous. This can also include identifying references to geographical locations in the events and determining which of these geographical locations are ambiguous, either globally or in a geographical area of interest. Identifying ambiguous geographical locations can be done by accessing a database of ambiguous geographical location descriptors and comparing the references to geographical locations with the ambiguous geographical location descriptors. Alternatively, the system can look up particular names in a database of locations as determine whether there are entries associated with multiple locations. For example, the system can look up “Paris” and determine that there are entries for Paris, France and Paris, Texas, USA. More generally, the system can determine from the database of locations whether the available information, e.g., City=Springfield, Country=USA, time zone= . . . , fits more than one location.

Finally, the system determines (103) an estimate of the geographical location of a particular device taking into account the events of the device that contain ambiguous geographical location information. In some implementations, the system does not use the identified ambiguous events at all to determine the estimate of geographical location of the device.

In other implementations, the ambiguous events are included in the determination of an estimate of geographical location, as will be described below. For example, the multiple events obtained at the system will likely also include unambiguous events. Then, an initial estimate of geographical location of a device or a group of devices can be determined (103a) based on the unambiguous events. This can include calculating a most probable geographical location of the device or the group of devices. For instance, a center of gravity can be calculated based on the unambiguous events. This center of gravity can be the most probable geographical location.

Alternatively, the geographical location contained in a majority of unambiguous queries can be regarded as most probable geographical location of the device or the group of devices by the system.

In a next step, (103b) the ambiguities in the ambiguous events are resolved based on the initial estimate of geographical location. For instance, the alternative geographical location closest to the most probable geographical location previously determined is selected to resolve the ambiguities. Alternatively, the ambiguity can be resolved by selecting one of the possible event locations or by giving different weights to different event locations.

In a subsequent step, (103c) after having resolved the ambiguities in the ambiguous events, the system determines a final estimate of geographical location of the device or the group of devices based on the originally unambiguous events and the previously ambiguous events whose ambiguities have been resolved. This final estimate might be more accurate than the initial estimate since a larger number of events is used by the system to determine it.

In another example of determining an estimate of the geographical location of the device uses a two-step estimation of a geographical location. The system determines a value indicative of the probability that a device or a group of devices are located at each of a set of candidate geographical locations. For example, the system can count, in a first step, the appearances of the candidate geographical locations in the unambiguous events. The system can calculate the value indicative of the probability that a device or a group of devices is located at a certain geographical location as the number of appearances of the respective geographical location in the obtained events plus the number of appearances of other geographical locations in the events, where the number of appearances of the other geographical locations is weighted by a weighting factor.

In one example, the weighting factor decreases with increasing geographical distance between a respective geographical location and the other geographical location. In this manner, not only the events including the respective geographical location itself, but also events including other geographical locations, influence the value indicative of the probability that a device or a group of devices is located at the respective geographical location; and proximate geographical locations have larger influence than remote ones.

The system uses the values indicative of the probability that a device or a group of devices is located at a certain geographical location to resolve the ambiguities in the ambiguous events, as described above. This can include transforming each ambiguous event into one event related to the geographical location among the alternative geographical locations which is closest to a most probable geographical location determined in the previous step.

The system repeats the step of calculating values indicative of the probability that a device or a group of devices is located at certain geographical locations as the number of appearances of the respective geographical location in the obtained events plus the number of appearances of other geographical locations in the events. The weighting factors described above can be employed.

In the implementations of 103b described above, ambiguous events have been disregarded or regarded as relating to a single geographical location. In alternative implementations, the ambiguity can be left unresolved and replaced by a weighting of the different possibilities, the above strict resolution would then correspond to weights 0 and 1, and only one possibility would get weight 1. For example, a route query including a start geographical location and a destination geographical location, where both locations are approximately in the same distance, can be regarded as being related to both the start and destination geographical locations.

In some implementations, the system counts the ambiguous events with the same strength for all alternative geographical locations they relate to. For instance, an ambiguous event can be counted as multiple different events, one for every alternative geographical location in the geographical area of interest. While this might improve the accuracy of the geographical location estimate, for example as compared to ignoring ambiguous events altogether, in some situations, it might worsen the estimate in other situations. For example, in a case where a city is one candidate geographical location and its different suburbs are further geographical locations, route queries frequently include one geographical location situated in the suburbs and a second located in the city. Counting these route queries for both geographical locations might bias the estimate for geographical location towards the city. This can be avoided by only using the most likely location as in the above implementation of (103b), but also in this “weighted” alternative by including weighting factors for varying the influence of the different alternative geographical locations on the estimate of geographical location of a device or a group of devices.

For example, these weighting factors can decrease with an increasing distance to a most probable geographical location of a device or a group of devices calculated without taking the ambiguous events into account.

The weighting factor can be chosen according to any functional relationship of the distance between the most probable geographical location according to an initial estimate and the respective alternative geographical location. For example, the weighting factor might decrease linearly or exponentially with increasing distance between the most probable geographical location according to a first estimate and the respective alternative geographical location.

The weights are then normalized by dividing by the sum of weights, such that the ambiguous event gets locations with weights that sum up to one—so in total the ambiguous events are used with the same weight as the unambiguous events.

Additionally, in this normalization, the weighting factor for each alternative geographical location might be set to have a minimum value if it is too small. This has the effect that in cases with one or several locations too far away from the initial estimate a total weight of the event will be less than one. In particular, if all location candidates are very far away, the event will get a small total weight. This effectively eliminates unlikely alternatives in an event in step (103b) and “unusable” events from the location estimate in step (103c). In other implementations, the system may explicitly require that only alternative geographical locations closer than a predetermined threshold to a most probable geographical location according to first estimate are considered and the remaining alternative geographical locations are discarded. In this case, events with all location candidates too far away would be discarded completely.

Estimating Geographical Location Including Two or More Geographic Locations

An estimate of a geographical location of a device or a group of devices can contain just one geographical area or location, e.g., the one having highest probability.

However, in some examples, it is more useful to obtain an estimate of a geographical location that includes two or more geographical locations and respective probability values each representing a probability that a device or group of devices is located at the respective geographical location. The probability values define a probability distribution of geographical locations of a device or a group of devices. Optionally, the probability values or the probability distribution can be probability values or a probability distribution in a strict mathematical sense.

FIG. 2 is a flowchart of a method to estimate the geographical location distribution of a device or a group of devices based on events originating from the device or the group of devices. The method will be described as being performed by a system made up of one or more computers operating in one or more locations.

The system determines an estimate of a probability distribution of geographical locations for a device or group of devices. A probability value is determined for each of M candidate geographical locations a device can be located in. In a first step, the system obtains (201) N events that have been observed originating from the device or the group of devices whose geographical location is to be determined.

Thus, the candidate geographical locations form a set L of geographical locations having M members; the i-th member is denoted lᵢ. In the same manner, the obtained events form a set of events E having N members; the j-th member is denoted evⱼ. Both N and M are natural numbers.

In a subsequent step, the system obtains (202) probabilities that an i-th observed event evᵢ originated from a device or a group of devices given that the device or the group of devices is located at the j-th geographical location lⱼ. This step can be repeated for all obtained events and all candidate geographical locations. In this way, a set of conditional probabilities of the form P(evᵢ|lⱼ) can be generated or obtained. The conditional probabilities can be previously determined and stored in a database, from which the system can request any required conditional probabilities for an obtained event. In some implementations, the system estimates p(ev|l) for each of a set of IP address blocks. For example, given a particular IP address block, the likelihood of a particular observed event from that particular block b, N(ev|b), can be determined from observed query data in a particular time span. Therefore, the location of the IP address block b can be estimated from the observed N(ev|b) if it is assumed that all users are in approximately the same location (loc) and the event locations are clustered around this loc.

The system calculates a probability distribution of geographical location X of the device or the group of devices from the conditional probabilities obtained for the obtained set of events from the estimated p(ev|l) and the observed events from the device(s). The distribution X has a probability value X(l) for every one of the M geographical locations in the set L; however, in practice, the data can be stored in a compressed form, where many of the values are zero. This calculation of X can include evaluating (203) an expression for the likelihood that the observed set of events originated from a device or a group of devices distributed according to a probability distribution of geographical locations. This likelihood is unknown, but it can be expressed by the conditional probabilities obtained previously and the probability distribution of geographical locations.

For instance, the system can determine a probability distribution of geographical locations maximizing this unknown likelihood. This maximization can be performed without actually determining the unknown likelihood that the observed set of events originated from a device or a group of devices distributed according to a probability distribution of geographical locations.

For example, the likelihood that the observed set of events originated from a device or a group of devices distributed according to a probability distribution of geographical locations D(E|X) can be expressed as:

$$log D ( E \vert X ) = log {Π}_{ev ∈ E} D ( ev \vert X ) = {Σ}_{ev ∈ E} log D ( ev \vert X ) = {Σ}_{ev ∈ E} log {Σ}_{t ∈ L} X ( l ) P ( ev \vert l ) .$$

A probability distribution of geographical location X that maximizes this expression is determined. This can be done using an expectation-maximization process, for example, which will now be described.

In an initial step, the system initializes (204) the probability distribution of geographical locations X. This can include, for instance, assigning an equal probability value to all geographical locations the probability distribution covers.

In another example, a most likely location of the device or the group of devices is assigned the probability one and the remaining geographical locations are assigned the probability zero. The most likely location can have been determined previously and/or by a different estimation scheme.

Then, the system performs an iterative procedure which first includes an expectation step (205), yielding an update for the conditional probabilities q(l|ev), which indicate the probability that a device is located in a geographical location l given that an event ev is observed. The expectation step can include calculating (404) these conditional probabilities q(l|ev) according to:

$$q ( l \vert ev ) = \frac{P ( ev \vert l ) {X}^{t} ( l )}{{Σ}_{{l}^{′} ∈ L} P ( ev \vert {l}^{′} ) {X}^{t} ( {l}^{′} )}$$

In the subsequent maximization step, the system uses these updated conditional probabilities q(l|ev) in an expression to determine (206) an updated probability distribution of geographical location X^{t+1} (l):

$${X}^{t + 1} ( l ) = \frac{{Σ}_{ev ∈ E} q ( l \vert ev )}{{Σ}_{{l}^{′} ∈ L} {Σ}_{ev ∈ E} q ( {l}^{′} \vert ev )}$$

In the following expectation step, the system uses the updated probability distribution of geographical location X^{t+1} (l) to obtain an updated set of conditional probabilities q(l|ev), which then are used to obtain the next probability distribution of geographical location X^{t+2} (l) and so on.

This iteration can be continued until an exit criterion is fulfilled (“yes” branch from 207). This can include determining if the change in a last step is lower than a predetermined threshold, or that the change in a last number of steps was lower than a predetermined threshold. Other exit criteria can include a maximum number of iterations.

The then-current probability distribution can be used as an estimate for the probability distribution of the geographical locations of the device or the group of devices (208).

The methods described in reference to FIG. 2 can be modified to include ambiguous events.

In some implementations, each ambiguous event is transformed into a set of disambiguated events not containing ambiguous location information, where each of the disambiguated events is based on a respective one of the alternative geographical locations of the ambiguous event. Then, in the step of obtaining probabilities that an i-th event evᵢ has been obtained from a device or a group of devices located at the j-th geographical location lⱼ, a separate probability is obtained for each disambiguated event. Thus, for an ambiguous event with m possible alternative geographical locations, m different conditional probabilities P(evₖ|l) can be obtained, with k running from 1 to m. Note that the locations are given, e.g., by longitude and latitude and therefore are not ambiguous. However, what is ambiguous is the meaning of the event as described below.

For instance, in an example where a search event includes an ambiguous city name, a separate value indicative that this event was received from a device located in each of the alternative geographical locations is obtained. This can include, e.g., conditional probabilities of the form P(q|“city name #n”).

Alternatively, instead of transforming each ambiguous event into a set of disambiguated events, the ambiguous events can be modeled by a modified set of events.

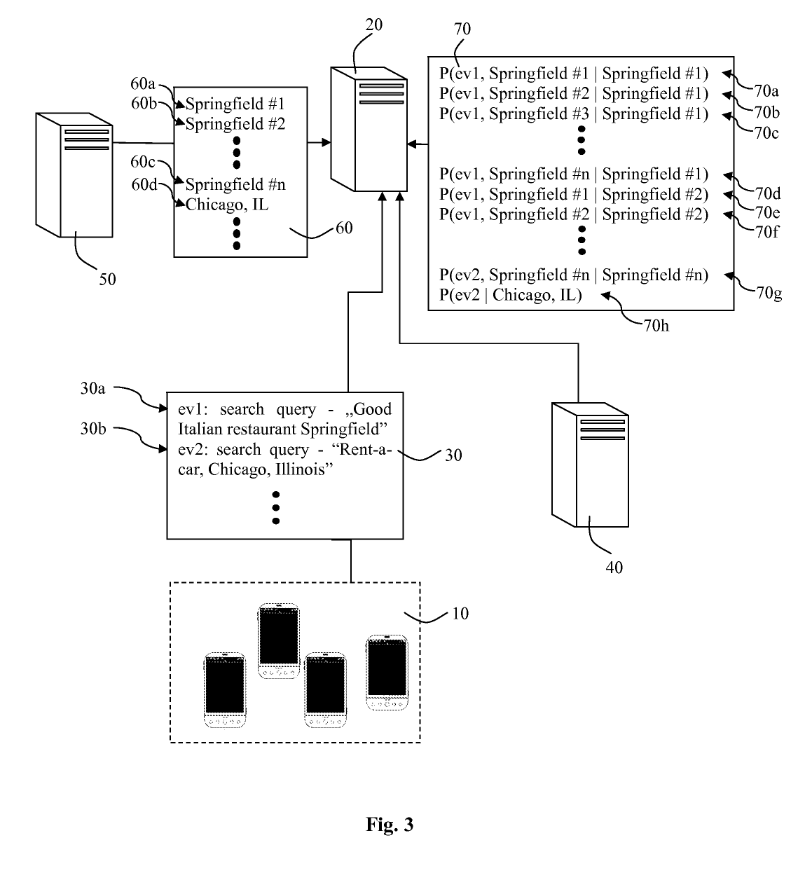

FIG. 3 is a schematic drawing of an example diagram including systems in which the methods for geographical location of devices described in this specification can be carried out.

A system 20 obtains events 30 from a group of devices 10 to be located. This set of events 30 includes ambiguous events 30a as well as unambiguous events 30b. The events can include queries, as illustrated.

The system 20 analyzes the set of events 30 and identifies ambiguous geographical location information contained in the set of events 30. This can include obtaining geographical location information 60 from a geographical location database 50 and using the information 60 to identify ambiguous geographical location information.

In the example of FIG. 3, the system 20 treats each ambiguous event 30a as including an ambiguous part, which has been observed, and a latent part, which has not been observed. The latent part can be chosen to resolve the ambiguity. The ambiguous events 30a include a name of a geographical location existing multiple times in a geographical area of interest. The name of the geographical location corresponds to the observed part. The latent part identifies one of the multiple alternative geographical locations.

As noted earlier, ambiguous events can contain route queries. In such events, the observed part can include the start and destination geographical location information. The latent part can identify which geographical location is closer to the device issuing the query.

Each ambiguous event can be split into the observed ambiguous part a and the latent part y. The latent parts y form a set S(a) for every ambiguous event, having as many members as there are alternative geographical locations for the respective ambiguous events.

For all unambiguous events 30b, the system 20 obtains conditional probabilities 70h that an i-th event evᵢ has been observed from the group of devices 10 given that the group of devices 10 is located at the j-th geographical location lⱼ as in the method of FIG. 2 (202), for all geographical locations and events.

For the ambiguous events 30b, the system 20a obtains a modified set of conditional probabilities 70a-g. The system 20 obtains a conditional probability 70a-g for each disambiguation that an i-th event aᵢ has been obtained given that the group of devices 10 is located at a j-th geographical location lⱼ. In the example of FIG. 3, the system can obtain conditional probabilities 70a-g of the form P(aᵢ, y_{i,k}|lⱼ), where k runs from 1 to the number of alternative geographical location for the respective ambiguous query.

The conditional probabilities 70a-h are previously determined. For example, they can be generated by the system 20 using a historical event database 40. Alternatively, the conditional probabilities 70a-h can also be stored locally on system 20.

These “unambiguated” probabilities can be derived from unambiguous events: If there are observed event queries, “(e.g., Pizzeria in) Springfield, Ill. 85032”, then this provides information that the system uses for the “unambiguated forms” of “(e.g. Schools in) Springfield”. Less obvious may be the case of driving directions: If the observed events include “driving directions between A and B”, the unambiguated versions will use (“driving directions between A and X”|l) for all X and locations 1 such that A is closer to 1 than X for the one case (y=“A is closer to the user than B”), and P(“driving directions between B and X” |l) for all X and 1 such that B is closer to 1 than X for the other case (y=“B is closer to the user than A”).

The conditional probabilities P(aᵢ, y_{i,k}|lⱼ) are used to determine a most likely probability distribution of geographical location X of the group of devices 10. The expectation-maximization process is adapted as will be now described.

In an initial step, the system 20 initializes a probability distribution of geographical locations X.

Then, the system 20 carries out an iterative procedure which in turn performs the expectation step, yielding an update for the conditional probabilities q(l, y|a). The conditional probabilities q(l, y|a) indicate that an obtained event 30a, 30b originated from a device at a geographical location l and is disambiguated by y, given that the respective event a was observed. The expectation step includes calculating latent variables q(l, y|a) according to:

$$q ( l , y \vert a ) = \frac{P ( a , y \vert l ) {X}^{t} ( l )}{{Σ}_{{l}^{′} ∈ L} {Σ}_{y ∈ S ( a )} P ( a , y \vert {l}^{′} ) {X}^{t} ( {l}^{′} )}$$

where the superscript t on X is used to indicate the iteration in which X is computed.

In a subsequent maximization step, the system 20 uses these updated conditional probabilities q(l, y|a) to determine an updated probability distribution of geographical location X^{t+1} (l):

$${X}^{t + 1} ( l ) = \frac{1}{N} {\sum }_{i = 1}^{N} {\sum }_{y ∈ S ( a )} q ( l , y \vert {a}_{i} )$$

In a next expectation step, the system 20 uses the updated probability distribution of geographical location X^{t+1} (l) to obtain an updated set of latent variable conditional probabilities q(l, y|a), which then are used to obtain the next probability distribution of geographical location X^{t+2} (l).

This iteration can be continued until an exit criterion is fulfilled, as was described in reference to FIG. 2.

The latent part of an ambiguous event can take its different values with a predetermined probability. For example, in the case of route queries, where it is not known which of two geographical locations included in the route query is a start and which is a destination geographical location, the latent part can indicate whether the route query goes from near to far or the other way around. The probability for each of the two values for the latent part can be fixed. In some examples, the probability can be 50% for each of the two values. However, if the system 20 has data indicating that users favor one way of formulating the route query over the other, these probability values can be adapted accordingly.

In some cases, the system 20 can employ only a portion of the conditional probabilities P(aᵢ, y_{i,k}|lⱼ). For example, in the case of route queries, the system 20 can use only the closer geographical location given a respective geographical location of a device or group of devices. This can be done by setting the conditional probability belonging to the other geographical location to zero.

The methods described in reference to FIGS. 1 to 3 can be implemented for all network devices, including, e.g., routers, hubs, switches, bridges, and repeaters, as well as servers and server systems. However, user devices are of particular interest. User devices include, for example, desktop computers, laptop computers, personal digital assistants, tablet computers, and smartphones. For non-user devices, an ambiguous event can contain a name or part of a name accessible over a network. For example, a name of a router can include geographical location information relating to different alternative geographical locations.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, for example, a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media, for example, multiple CDs, disks, or other storage devices.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program, also known as a program, software, software application, script, or code, can be written in any form of programming language, including compiled or interpreted languages and declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files, for example, files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of nonvolatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data, for example, an HTML page, to a client device, for example, for purposes of displaying data to and receiving user input from a user interacting with the client device. Data generated at the client device, for example, a result of the user interaction, can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing system, the method comprising:
obtaining device information associated with a first device located at a respective geographical location, the device information including a plurality of events obtained from the first device, wherein least a one event of the obtained events contains ambiguous geographical location information that can be interpreted as relating to one of two or more alternative geographical locations;
identifying the at least one event containing ambiguous geographical location information; and
determining an estimate of the geographical location of the first device based at least in part on the device information taking into account that the at least one identified event contains ambiguous geographical location information.

2. The method of claim 1, wherein the at least one event containing ambiguous geographical location information is not used to determine the estimate of geographical location of the first device.

3. The method of claim 1, wherein determining an estimate of the geographical location of the first device includes:
determining a first estimate of geographical location without taking the at least one event containing ambiguous geographical location information into account;
resolving the ambiguity in the at least one event containing ambiguous geographical location information based on the first estimate of geographical location, wherein resolving the ambiguity includes selecting one of the two or more alternative geographical locations the event relates to; and
determining a second estimate of geographical location based also on the at least one event with a resolved ambiguity.

4. The method of claim 3, wherein the first estimate of geographical location includes a most probable geographical location of the first device, and
wherein resolving the ambiguities includes selecting a geographical location of the two or more alternative geographical locations which is closest to the most probable geographical location of the first device according to the first estimate.

5. The method of claim 1, wherein determining an estimate of the geographical location of the first device includes:
determining a first estimate of geographical location without taking the at least one event containing ambiguous location information into account, wherein the first estimate of geographical location includes a most probable geographical location of the first device;
generating for each of the of two or more alternative geographical locations of the at least one event containing ambiguous location information a disambiguated event not containing ambiguous location information, and
determining a second estimate of geographical location taking into account the disambiguated events, wherein each of the disambiguated events is weighted according to the geographical distance of the geographical location it relates to compared to the most probable geographical location of the first device according to the first estimate of geographical location of the first device.

6. The method of claim 5, further comprising:
disregarding events among the disambiguated events generated from the at least one event if a geographical location the respective event relates to is farther away from the most probable geographical location of the first device according to the first estimate than a predetermined threshold.

7. The method of claim 1, wherein the estimate of geographical location includes a probability distribution of geographical locations which includes a probability value for each of two or more geographical locations expressing a probability that the first device is located at the respective geographical location.

8. The method of claim 1, wherein the first device belongs to a first group of devices,
wherein the probability distribution is a probability distribution of geographical locations of the first group of devices, and
wherein the determining step includes determining an estimate of the probability distribution of geographical locations of the first group of devices.

9. The method of claim 1, further comprising:
obtaining device information associated with a second device belonging to the first group of devices located at a respective geographical location including obtaining a plurality of events obtained from the second device, wherein least a one event of the events obtained from the second device contains ambiguous geographical location information that can be interpreted as relating to one of two or more alternative geographical locations; and
identifying the at least one event of the events obtained from the second device containing ambiguous geographical location information;
wherein determining the estimate of the probability distribution of geographical locations is based on events obtained from the first device and the second device.

10. The method of claim 9, further comprising:
generating for each of the of two or more alternative geographical locations of the at least one event containing ambiguous location information a disambiguated event not containing ambiguous location information, and
obtaining for the geographical locations of two or more geographical locations and for the disambiguated events, a probability value indicative of a probability that a respective query originated from a device located at the respective geographical location; and
wherein determining the estimate of the probability distribution of geographical locations includes processing the probability values obtained.

11. The method of claim 10, wherein each probability value includes a conditional probability that a respective event occurred given that the device the event originated from is located at a respective geographical location.

12. The method of claim 10, wherein determining an estimate of the geographical location of the first device includes:
initializing a current probability distribution of geographical locations with an initial set of probability values;
iterating, until an exit criterion is fulfilled, the actions of:
computing for all events and the two or more geographical locations, a new value for conditional probabilities that a device is at a certain location given that a certain event is observed based on the current probability distribution of geographical locations and the probabilities that the certain event occurred given that a device is located at a certain geographical location; and
computing a new current probability distribution of geographical locations based on the current values that a device is at a certain location given that the certain event is observed.

13. A system comprising:
one or more computers configured to perform operations comprising:
obtaining device information associated with a first device located at a respective geographical location, the device information including a plurality of events obtained from the first device, wherein least a one event of the obtained events contains ambiguous geographical location information that can be interpreted as relating to one of two or more alternative geographical locations;
identifying the at least one event containing ambiguous geographical location information; and
determining an estimate of the geographical location of the first device based at least in part on the device information taking into account that the at least one identified event contains ambiguous geographical location information.

14. The system of claim 13, wherein determining an estimate of the geographical location of the first device includes:
determining a first estimate of geographical location without taking the at least one event containing ambiguous geographical location information into account;
resolving the ambiguity in the at least one event containing ambiguous geographical location information based on the first estimate of geographical location, wherein resolving the ambiguity includes selecting one of the two or more alternative geographical locations the event relates to; and
determining a second estimate of geographical location based also on the at least one event with a resolved ambiguity.

15. The system of claim 13, wherein determining an estimate of the geographical location of the first device includes:
determining a first estimate of geographical location without taking the at least one event containing ambiguous location information into account, wherein the first estimate of geographical location includes a most probable geographical location of the first device;
generating for each of the of two or more alternative geographical locations of the at least one event containing ambiguous location information a disambiguated event not containing ambiguous location information, and
determining a second estimate of geographical location taking into account the disambiguated events, wherein each of the disambiguated events is weighted according to the geographical distance of the geographical location it relates to compared to the most probable geographical location of the first device according to the first estimate of geographical location of the first device.

16. The system of claim 13, further configured to perform operations comprising:
obtaining device information associated with a second device belonging to the first group of devices located at a respective geographical location including obtaining a plurality of events obtained from the second device, wherein least a one event of the events obtained from the second device contains ambiguous geographical location information that can be interpreted as relating to one of two or more alternative geographical locations; and
identifying the at least one event of the events obtained from the second device containing ambiguous geographical location information;
wherein determining the estimate of the probability distribution of geographical locations is based on events obtained from the first device and the second device.

17. A computer storage medium encoded with a computer program, the program comprising instructions that when executed by one or more computers cause the one or more computers to perform operations comprising:
obtaining device information associated with a first device located at a respective geographical location, the device information including a plurality of events obtained from the first device, wherein least a one event of the obtained events contains ambiguous geographical location information that can be interpreted as relating to one of two or more alternative geographical locations;
identifying the at least one event containing ambiguous geographical location information; and
determining an estimate of the geographical location of the first device based at least in part on the device information taking into account that the at least one identified event contains ambiguous geographical location information.
